(19) United States
(12) Patent Application Publication
(10) Pub. No.: US 2021/0276493 A1
(43) Pub. Date: Sep. 9, 2021

(54) VEHICLE RACK RAMP DEVICE

(71) Applicant: Awesome Things That Work, LLC, CHAPEL HILL, NC (US)

(72) Inventors: Joseph C. Neill, North Bend, OR (US); James C. Neill, Chapel Hill, NC (US)

(73) Assignee: Awesome Things That Work, LLC, CHAPEL HILL, NC (US)

(21) Appl. No.: 17/093,752

(22) Filed: Nov. 10, 2020

Related U.S. Application Data
(60) Provisional application No. 62/986,640, filed on Mar. 7, 2020.

(51) Int. Cl. B60R 9/042; B60R 9/08

(52) U.S. Cl. CPC B60R 9/042; B60R 9/08

(57) ABSTRACT

A vehicle rack ramp device may include a ramp having one or more sections, such as a base section, one or more mid sections, and a top section. Preferably, the sections of a ramp may be coupled together so that the base section and top section are separated by one or more mid sections. The base section may have a base surface, each mid section may have a mid surface, and the top section may have a top surface. A cushion may be coupled to the top section. A vehicle retainer may also be coupled to the top section so that the vehicle retainer may be positioned closer to the distal end than to the proximal end. Preferably, the sections may be coupled together so that their respective surfaces are substantially continuous with each other.

### CROSS REFERENCE TO RELATED APPLICATIONS

This application claims priority to and the benefit of the filing date of U.S. Provisional Application No. 62/986,640, filed on Mar. 7, 2020, entitled “Easy Rack Ramp”, which is hereby incorporated by reference in its entirety.

### FIELD OF THE INVENTION

This patent specification relates to the field of devices for facilitating the loading and unloading of objects onto the roofs of vehicles. More specifically, this patent specification relates to a collapsible device which is configured to provide a ramp for facilitating the loading and unloading of objects onto the roofs of vehicles.

### BACKGROUND

Loading an item onto the roof or a roof rack of a vehicle typically requires an individual to lift the item above head height. This is awkward and dangerous. Not only can it result in damage to the vehicle, but if it is done improperly it can also result in injury to the individual.

Devices exist that attempt to enable an individual or to facilitate an individual with loading and unloading items onto a vehicle. These devices have included ramps, hydraulic lifts, extension rails, rollers and winches. However, these devices suffer from one or more of the following drawbacks: they are heavy and/or bulky so as to be troublesome to move and use; they are cost prohibitive or at least expensive; they have many moving parts which increase the chances of breakage; and they are only suitable for use with a limited number of objects and vehicles.

Therefore, a need exists for novel devices for facilitating the loading and unloading of objects onto the roofs of vehicles. A further need exists for novel collapsible devices which are configured for facilitating the loading and unloading of objects onto the roofs of vehicles and which do not suffer from the drawbacks associate with existing devices.

### BRIEF SUMMARY OF THE INVENTION

A vehicle rack ramp device is provided which may be configured to facilitate the ability of a user to load and unload objects onto the roofs of vehicles. In some embodiments, the device may include one or more ramps. Each ramp may comprise one or more sections, such as a base section, one or more mid sections, and a top section. Preferably, the sections of a ramp may be coupled together so that the base section and top section are separated by one or more mid sections. The base section may have a base surface, each mid section may have a mid surface, and the top section may have a top surface that may be disposed between a distal end and a proximal end of the top section. A cushion may be coupled to the top section so that the cushion may be positioned closer to the distal end than to the proximal end. A vehicle retainer may also be coupled to the top section so that the vehicle retainer may be positioned closer to the distal end than to the proximal end. Preferably, the sections may be coupled together so that their respective surfaces are substantially continuous with each other. A user may use the device by placing the one or more ramps so that the base section is in contact with a ground surface and by coupling the top section to a portion of a vehicle, such as a roof rack, with the vehicle retainer while the cushion may rest against the vehicle and prevent the device from damaging the vehicle. The user may then move an object, such as a canoe across the surfaces so that the device bears most of the weight of the object to facilitate the user's ability to load and unload the object to and from the vehicle.

In further embodiments, the device may include a ramp having: an elongated base section having a base surface; an elongated first mid section having a first mid surface; an elongated second mid section having a second mid surface; an elongated top section having a top surface, a distal end, and a proximal end; a cushion coupled to the top section so that the cushion is positioned closer to the distal end than to the proximal end; and a vehicle retainer coupled to the top section so that the vehicle retainer is positioned closer to the distal end than to the proximal end. The base section may be removably coupled to the first mid section so that the base surface may be substantially continuous with the first mid surface, the first mid section may be removably coupled to the second mid section so that the first mid surface may be substantially continuous with the second mid surface, and the proximal end of the top section may be removably coupled to the second mid section so that the second mid surface may be substantially continuous with the top surface.

In still further embodiments, the device may include a ramp having: an elongated base section having a base surface; an elongated first mid section having a first mid surface; an elongated top section having a top surface, a distal end, and a proximal end; a cushion coupled to the top section so that the cushion is positioned closer to the distal end than to the proximal end; and a vehicle retainer coupled to the top section so that the vehicle retainer is positioned closer to the distal end than to the proximal end. The base section may be removably coupled to the first mid section so that the base surface may be substantially continuous with the first mid surface, and the proximal end of the first top section may be removably coupled to the first mid section so that the first mid surface may be substantially continuous with the top surface.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of a vehicle rack ramp device having two ramps that may be removably coupled to a vehicle or other object according to various embodiments described herein.

FIG. 2—FIG. 2 illustrates a front perspective view of an example of a vehicle rack ramp device having one ramp that includes a base section, two mid sections, and a top section according to various embodiments described herein.

FIG. 3—FIG. 3 shows a rear perspective view of the example vehicle rack ramp device of FIG. 2 according to various embodiments described herein.

FIG. 4—FIG. 4 depicts a front perspective view of an example of a vehicle rack ramp device having one ramp that includes a base section, a mid section, and a top section according to various embodiments described herein.

FIG. 5—FIG. 5 illustrates a rear perspective view of the example vehicle rack ramp device of FIG. 4 according to various embodiments described herein.

FIG. 6—FIG. 6 shows a front perspective view of an example of a top section according to various embodiments described herein.

FIG. 7—FIG. 7 depicts a rear perspective view of an example of a top section according to various embodiments described herein.

FIG. 8—FIG. 8 illustrates a perspective view of an example of a mid section according to various embodiments described herein.

FIG. 9—FIG. 9 shows a perspective view of an example of a bottom section according to various embodiments described herein.

FIG. 10—FIG. 10 depicts a sectional elevation view of an example of a top section coupled to a mid section according to various embodiments described herein.

FIG. 11—FIG. 11 illustrates a perspective view of an example of a top section removably coupled to a vehicle according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

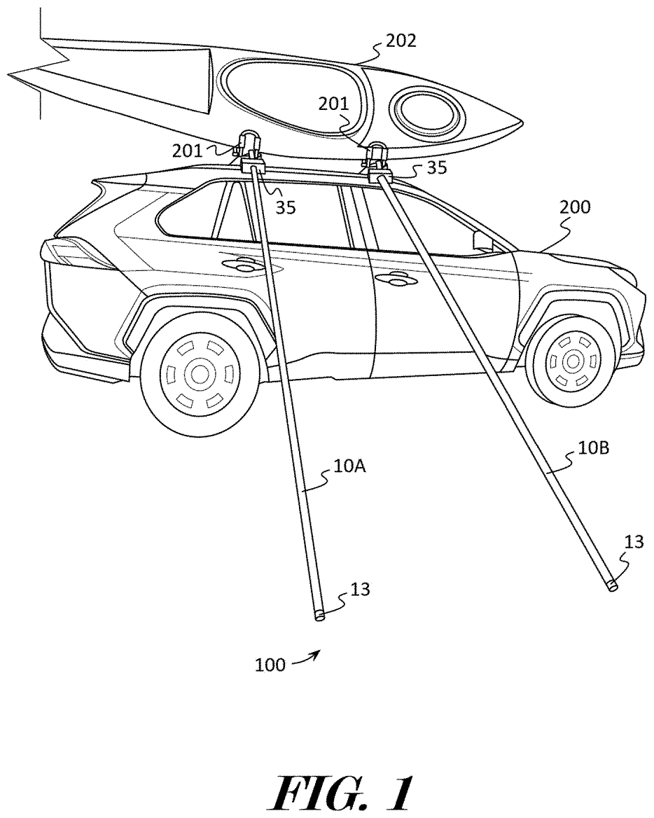

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new vehicle rack ramp device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIG. 1 illustrates an example of a vehicle rack ramp device (“the device”) 100 according to various embodiments. In some embodiments, the device 100 may comprise one or more ramps 10, such as a first ramp 10A and a second ramp 10B. Each ramp 10A, 10B, may comprise one or more sections, such as a base section 11, one or more mid sections 21, and a top section 31. The sections 11, 21, 31, may be coupled together so that the base section 11 and top section 31 are separated by one or more mid sections 21. The base section 11 may have a base surface 12, each mid section 21 may have a mid surface 22, and the top section 31 may have a top surface 32 that may be disposed between a distal end 33 and a proximal end 34. A cushion 35 may be coupled to the top section 31 so that the cushion 35 may be positioned closer to the distal end 33 than to the proximal end 34. A vehicle retainer 36 may also be coupled to the top section 31 so that the vehicle retainer 36 may be positioned closer to the distal end 33 than to the proximal end 34. Preferably, the sections 11, 21, 31, may be coupled together so that their respective surfaces 12, 22, 32, are substantially continuous with each other. A user may use the device 100 by placing the one or more ramps 10A, 10B, so that the base section 11 is in contact with a ground surface and by coupling the top section 31 to a portion of a vehicle 200, such as a roof rack 201, with the vehicle retainer 36 while the cushion 35 may prevent the device 100 from damaging the vehicle 200. The user may then move an object, such as a canoe 202 across the surfaces 12, 22, 32, so that the device 100 bears most of the weight of the object to facilitate the user's ability to load and unload the object to and from the vehicle 200.

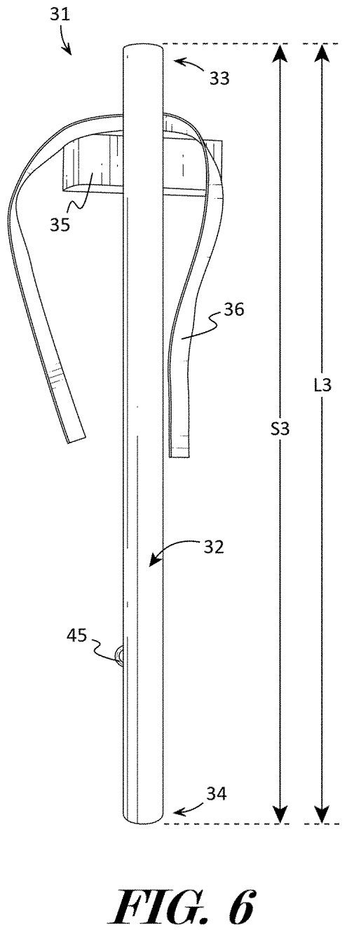

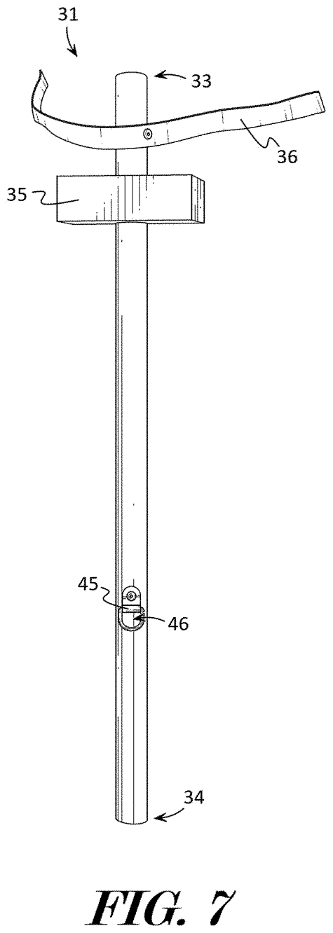

As perhaps best shown in FIGS. 6 and 7, a top section 31 may be elongated so as to have a top length dimension (L3) that is substantially greater than its width and height dimensions. Each top section 31 may comprise one or more top surfaces 32 which may extend along its top length dimension (L3). The top length dimension (L3) may describe the overall length of the top section 31, and the top surface dimension (S3) may describe the overall length of the one or more top surfaces 32. In some embodiments, a top section 31 may comprise a top surface dimension (S3) that extends at least 50 percent of the top length dimension (L3). In preferred embodiments, a top section 31 may comprise a surface dimension (S3) that extends at least 80 percent of the top length dimension (L3). In further embodiments, a top section 31 may comprise a top surface dimension (S3) that may be substantially equal to the top length dimension (L3) as shown in FIG. 6.

The device 100 may comprise one or more cushions 35 which may be coupled anywhere on the one or more ramps 10A, 10B. In preferred embodiments, a cushion 35 may be coupled to a top section 31 so that the cushion 35 may be positioned closer to the distal end 33 than to the proximal end 34 of the top section 31. Any suitable method of coupling a cushion 35 to a section 11, 21, 31, may be used. For example, in some embodiments, a cushion 35 may be heat bonded or welded to a section 11, 21, 31, while in further embodiments, a cushion 35 may be coupled to a desired location on a section 11, 21, 31, by a user via adhesive tape or the like.

A cushion 35 may be configured in any shape and size. In some embodiments, a cushion 35 may comprise a generally rectangular prism shape as perhaps best shown in FIGS. 6, 7, and 11. Optionally, a cushion 35 may completely surround a top section 31 or other section 11, 21, or a cushion 35 may not completely surround a section 11, 21, 31, but only be coupled to portions of the section 11, 21, 31.

A cushion 35 may be made from or may comprise any material which may be suitable for contacting portions of a vehicle, vehicle rack, or other object, in a non-marring or non-damaging manner. In preferred embodiments, a cushion 35 may comprise resilient material, such as closed cell foams, open cell foams, silicone foam, rubber foam, urethane foams including plastic foams, neoprene foam, latex foam rubber, polyurethane foam rubber, or elastomer materials such as elastic plastics, elastic silicone, silicone rubber, elastic rubbers, or any other suitable elastomer or resilient material including combinations of materials. In further embodiments, a cushion 35 may comprise flexible plastics such as polyvinyl chloride, natural or synthetic rubber, synthetic fabrics such as polyester, acrylic, nylon, rayon, acetate, spandex, spandex blends, and Kevlar, and natural fabrics such as coir, cotton, hemp, jute, canvas, flax, leather, linen, ramie, wool, silk, or any other suitable flexible natural or synthetic material including combinations of materials.

The device 100 may comprise one or more vehicle retainer 36 which may be coupled anywhere on the one or more ramps 10A, 10B. In preferred embodiments, a vehicle retainer 36 may be coupled to a top section 31 so that the vehicle retainer 36 may be positioned closer to the distal end 33 than to the proximal end 34 of the top section 31. Any suitable method of coupling a vehicle retainer 36 to a section 11, 21, 31, may be used. For example, in some embodiments, a vehicle retainer 36 may be coupled to a section 11, 21, 31, with a rivet or other suitable fastener, while in other embodiments, a vehicle retainer 36 may be coupled to a section 11, 21, 31, via heat bonding, adhesive, etc.

A vehicle retainer 36 may be configured in any shape and size. In preferred embodiments, a vehicle retainer 36 may comprise an elongated length of a hook and loop fastener so that the vehicle retainer 36 may be wrapped around portions of a vehicle 200, such as a roof rack 201, and then those portions may be secured to other portions of the vehicle retainer 36 thereby removably coupling the vehicle retainer 36 to the vehicle 200. In further embodiments, a vehicle retainer 36 may comprise a length of flexible material, which may include flexible plastics, such as polyvinyl chloride, natural or synthetic rubber, synthetic fabrics such as polyester, acrylic, nylon, rayon, acetate, spandex, spandex blends, and Kevlar, and natural fabrics such as coir, cotton, hemp, jute, canvas, flax, leather, linen, ramie, wool, silk, or any other suitable flexible natural or synthetic material including combinations of materials, which may enable the vehicle retainer to be tied, wrapped around, or otherwise coupled to a vehicle 200. In still further embodiments, a vehicle retainer 36 may comprise a magnetic fastener, suction cup, or any other suitable fastener which may be used to couple a section 11, 21, 31, to a vehicle in a non-marring or non-damaging manner.

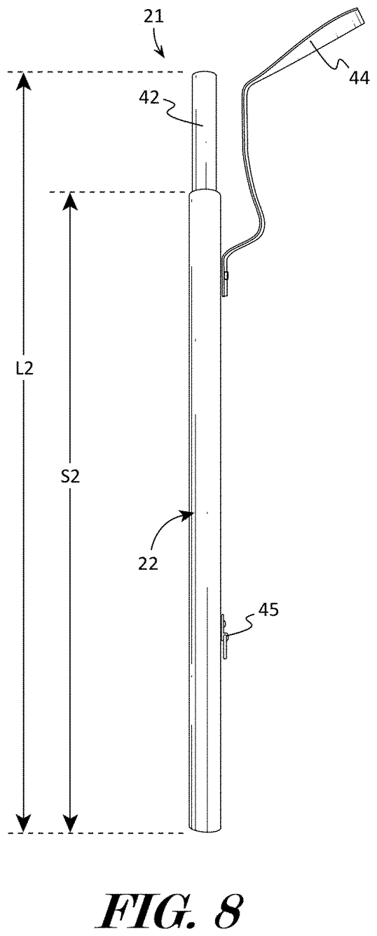

In some embodiments, the device 100 may comprise one or more mid sections 21. In other embodiments, the device 100 may comprise a base section 11 that may be coupled to a top section 31 without a mid section 21 positioned between the base 11 and top 31 sections. As perhaps best shown in FIG. 8, each mid section 21 may be elongated so as to have a mid length dimension (L2) that is substantially greater than its width and height dimensions. Each mid section 21 may comprise one or more mid surfaces 22 which may extend along its mid length dimension (L2). The mid length dimension (L2) may describe the overall length of the mid section 21 and the mid surface dimension (S2) may describe the overall length of the one or more mid surfaces 22. In some embodiments, a mid section 21 may comprise a mid surface dimension (S2) that extends at least 50 percent of the mid length dimension (L2). In preferred embodiments, a mid section 21 may comprise a mid surface dimension (S2) that extends at least 80 percent of the mid length dimension (L2). In further embodiments, a mid section 21 may comprise a mid surface dimension (S2) that may be substantially equal to the mid length dimension (L2).

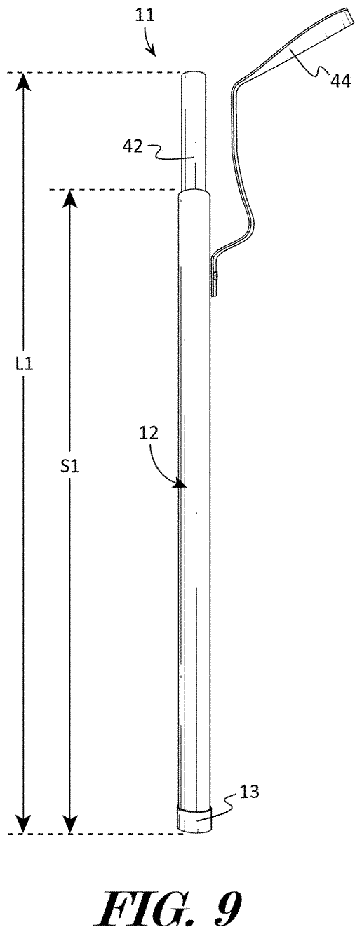

As perhaps best shown in FIG. 9, a base section 11 may be elongated so as to have a base length dimension (L1) that is substantially greater than its width and height dimensions. Each base section 11 may comprise one or more base surfaces 12 which may extend along its base length dimension (L1). The base length dimension (L1) may describe the overall length of the base section 11 and the base surface dimension (S1) may describe the overall length of the one or more base surfaces 12. In some embodiments, a base section 11 may comprise a base surface dimension (S1) that extends at least 50 percent of the base length dimension (L1). In preferred embodiments, a base section 11 may comprise a base surface dimension (S1) that extends at least 80 percent of the base length dimension (L1). In further embodiments, a base section 11 may comprise a base surface dimension (S1) that may be substantially equal to the base length dimension (L1).

In some embodiments, the device 100 may comprise a cap 13 which may be coupled to an end of a base section 11 that is opposite to an end of the base section 11 that may be coupled to a mid section 21. A cap 13 may be configured in any shape and size. Generally, a cap 13 may protect the bottom end of a base section 11 from dirt and other contaminants while also preferably being made of a material having a higher coefficient of friction than the material that the base section 11 may be made from. A cap 13 having a higher coefficient of friction than the material that the base section 11 may be made from may help to prevent the base section 11 from unintentionally sliding across a ground surface. Preferably, a cap 13 may be made from or may comprise a natural and/or synthetic material, which is flexible to allow slight deformation and resilient so as to return to its original shape after deformation. Example resilient materials include latex rubber, silicone rubber, forms of the organic compound isoprene, such as polyisoprene, Butyl rubber, Polyacrylate Rubber, Ethylene-acrylate Rubber, Polyester Urethane, Bromo Isobutylene Isoprene, Polybutadiene, Chloro Isobutylene Isoprene, Polychloroprene, Chlorosulphonated Polyethylene, Epichlorohydrin, Ethylene Propylene, Ethylene Propylene Diene Monomer, Polyether Urethane, Perfluorocarbon Rubber, Fluoronated Hydrocarbon, Fluoro Silicone, Fluorocarbon Rubber, Hydrogenated Nitrile Butadiene, Polyisoprene, Isobutylene Isoprene Butyl, Acrylonitrile Butadiene, Polyurethane, Styrene Butadiene, Styrene Ethylene Butylene Styrene Copolymer, Polysiloxane, Vinyl Methyl Silicone, Acrylonitrile Butadiene Carboxy Monomer, Styrene Butadiene Carboxy Monomer, Thermoplastic Polyether-ester, Styrene Butadiene Block Copolymer, and Styrene Butadiene Carboxy Block Copolymer.

The surfaces 12, 22, 32, of the sections 11, 21, 31, may form the portions of the sections 11, 21, 31, that an object may slide across as it is moved up and down a ramp 10A, 10B. In preferred embodiments, one or more surfaces 12, 22, 32, may be generally smooth or planar along at least one axis, such as the axis formed by aligning and coupling the sections 11, 21, 31, together. In further embodiments, one or more surfaces 12, 22, 32, may be textured or generally not smooth but which may still allow objects to slide across the one or more surfaces 12, 22, 32.

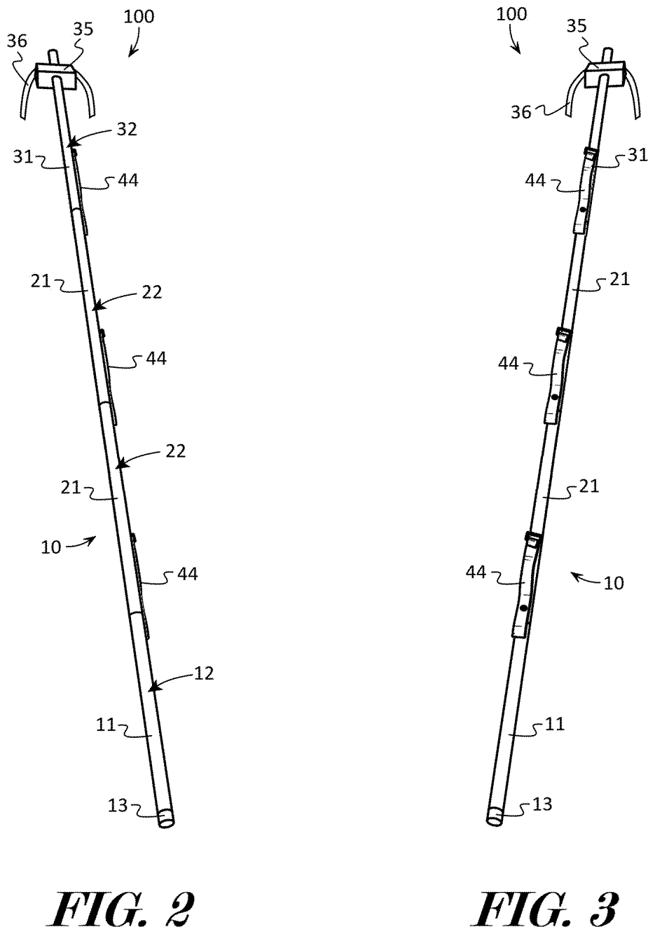

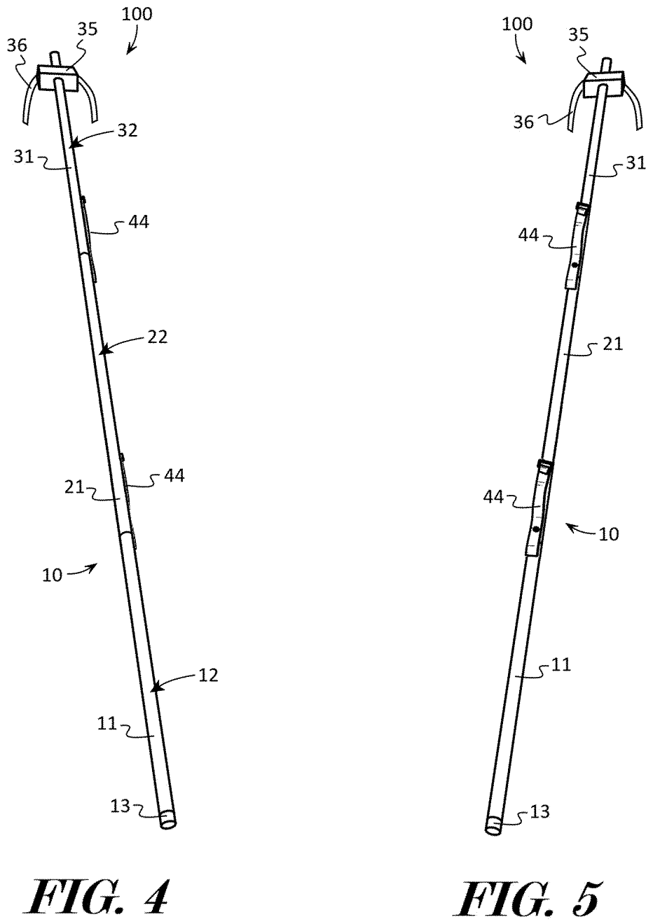

As perhaps best shown in FIGS. 2-5, the device 100 may be configured so that the surfaces 12, 22, 32, of the sections 11, 21, 31, may be at least generally continuous with each other when the sections 11, 21, 31, are coupled together to form a ramp 10A, 10B. In some embodiments, a surface 12, 22, 32, may be generally continuous with another surface 12, 22, 32, by having the surfaces 12, 22, 32, separated by a distance of between zero and five inches so that a gap of five inches or less may separate two surfaces 12, 22, 32, when their respective sections 11, 21, 31, are coupled together to form a ramp 10A, 10B. In further embodiments, a surface 12, 22, 32, may be approximately continuous with another surface 12, 22, 32, by having the surfaces 12, 22, 32, separated by a distance of between zero and two inches so that a gap of two inches or less may separate two surfaces 12, 22, 32, when their respective sections 11, 21, 31, are coupled together to form a ramp 10A, 10B. In preferred embodiments, a surface 12, 22, 32, may be substantially continuous with an adjacent surface 12, 22, 32, by having the surfaces 12, 22, 32, separated by a distance of between zero and one-half of an inch so that a gap of one-half of an inch or less may separate two surfaces 12, 22, 32, when their respective sections 11, 21, 31, are coupled together to form a ramp 10A, 10B. In this manner, each surface 12, 22, 32, may be substantially continuous with an adjacent surface 12, 22, 32, so that the surfaces 12, 22, 32, of the one or more ramps 10 may form a substantially continuous surface that is smooth, and free of any ridges, spaces, etc., at the joints between the surfaces 12, 22, 32, to facilitate sliding the load (e.g. canoe 202 or other object) on the ramp(s) 10 of the device 100.

The sections 11, 21, 31, may comprise any shape and size. In preferred embodiments, one or more sections 11, 21, 31, may comprise an elongated cylindrical shape. In further embodiments, one or more sections 11, 21, 31, may comprise an elongated rectangular prism shape, an elongated triangular prism shape, an elongated hexagonal prism shape, or any other shape including combinations of shapes.

The sections 11, 21, 31, may be made from or may comprise any substantially rigid material. In preferred embodiments, one or more sections 11, 21, 31, may be made from or may comprise fiberglass. For example, one or more sections 11, 21, 31, may comprise fiberglass tubing that may be approximately 1.5 inch diameter by 0.25 inch thick and approximately 30 inches long. In further embodiments, one or more sections 11, 21, 31, may be made from or may comprise steel alloys, aluminum, aluminum alloys, copper alloys, other types of metal or metal alloys, ceramics such as alumina, porcelain, and boron carbide, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, carbon fiber, resins, such as epoxy resin, wood, other plant based materials, or any other material including combinations of materials that are substantially rigid.

In preferred embodiments, the sections 11, 21, 31, may be removably coupled together to allow the device 100 to be disassembled into a compact state for storage or when not in use. In some embodiments, one or more sections 11, 21, 31, may be removably coupled or joined together by inserting a portion of one section 11, 21, 31, into a portion of another section 11, 21, 31. Preferably, one or more sections 11, 21, 31, may comprise a cavity 41 and the device 100 may comprise one or more inserts 42 which may be configured to be received in a cavity 41 of an adjacent section 11, 21, 31, in order two couple or join two sections 11, 21, 31.

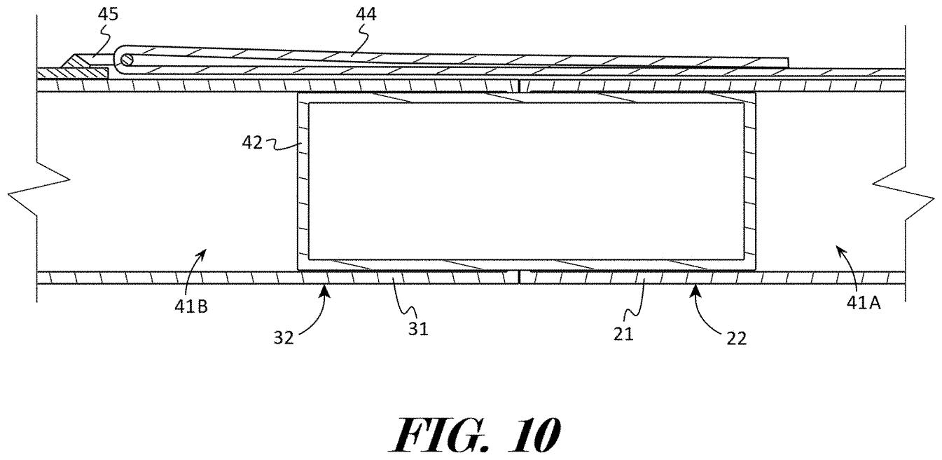

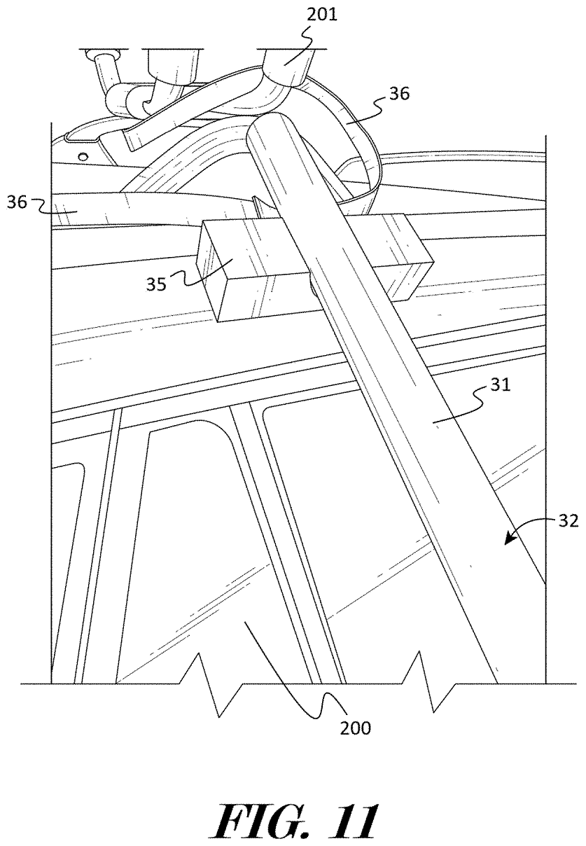

An example of a top section 31 coupled to a mid section 21 via an insert 42 is illustrated in FIG. 10. In the example, the insert 42 may be coupled or joined within a cavity 41A of the mid section 21 and removably coupled or joined in a cavity 41B of the top section 31 via a frictional fit. A section retainer 44 of the mid section 21 may be removably coupled to the section fastener 45 of the top section 31 to further removably couple the top section 31 and mid section 21 together. While FIG. 10 shows an example method of coupling a top section 31 to a mid section 21, it should be understood that any section 11, 21, 31, may comprise an insert 42 that may be inserted into a cavity 41 of an adjacent section 11, 21, 31, in order to couple or join the two sections 11, 21, 31, together. Likewise, any section 11, 21, 31, may comprise a section retainer 44 that may be engaged to a section fastener 45 of an adjacent section 11, 21, 31, in order to removably couple the two sections 11, 21, 31, together.

Generally, an insert 42 may be coupled to a first section 11, 21, 31, and the insert 42 may be sized and shaped to be received in the cavity 41 of an adjacent section 11, 21, 31, in order two couple two sections 11, 21, 31. As an example, two adjacent sections 11, 21, 31, may be made from fiberglass tubing having a central cavity 41 that may be approximately 1.5 inch diameter by 0.25 inch thick and an insert 42 may comprise tubing that may be 1.25 inches in diameter and 0.25 inch thick. The insert 42 may be coupled to a first section 11, 21, 31, so that the first section 11, 21, 31, comprises the insert 42, and the first section 11, 21, 31, may be coupled to a second section 11, 21, 31, by inserting the insert 42 into the cavity 41 of the second section 11, 21, 31.

In some embodiments, an insert 42 of a first section 11, 21, 31, may be frictionally retained in a cavity 41 of a second section 11, 21, 31, in order to removably couple the sections 11, 21, 31, together. In further embodiments, an insert 42 may be inserted in a cavity 41 and removably coupled therein via push-to-lock type connection method such as a ball and detent mechanism, a turn-to-lock type connection method, such as threading, a slide-to-lock type connection method or any other suitable temporary connection method as one reasonably skilled in the art could envision to serve the same function.

In some embodiments, a base section 11 may comprise an insert 42 and a mid section 21 may comprise a cavity 41, and the base section 11 may be coupled to the mid section 21 by inserting a portion (the insert 42) of the base section 11 into a portion (the cavity 41) of the mid section 21. In alternative embodiments, a base section 11 may comprise a cavity 41 and a mid section 21 may comprise an insert 42, and the base section 11 may be coupled to the mid section 21 by inserting a portion (the insert 42) of the mid section 21 into a portion (the cavity 41) of the base section 11.

In some embodiments, a first mid section 21 may comprise an insert 42 and a second mid section 21 may comprise a cavity 41, and the first mid section 21 may be coupled to the second mid section 21 by inserting a portion (the insert 42) of the first mid section 21 into a portion (the cavity 41) of the second mid section 21. In alternative embodiments, a first mid section 21 may comprise a cavity 41 and a second mid section 21 may comprise an insert 42, and the first mid section 21 may be coupled to the second mid section 21 by inserting a portion (the insert 42) of the second mid section 21 into a portion (the cavity 41) of the first mid section 21.

In some embodiments, a top section 31 may comprise an insert 42 and a mid section 21 may comprise a cavity 41, and the top section 31 may be coupled to the mid section 21 by inserting a portion (the insert 42) of the top section 31 into a portion (the cavity 41) of the mid section 21. In alternative embodiments, a top section 31 may comprise a cavity 41 and a mid section 21 may comprise an insert 42, and the top section 31 may be coupled to the mid section 21 by inserting a portion (the insert 42) of the mid section 21 into a portion (the cavity 41) of the top section 31.

In some embodiments, two or more sections 11, 21, 31, may be removably coupled together via one or more section retainers 44 and section fasteners 45 which may be removably engaged together. In some embodiments, one or more sections 11, 21, 31, may have one or more section retainers 44 and/or section fasteners 45 coupled to the one or more sections 11, 21, 31. In further embodiments, a section fastener 45 may comprise a fastener having an aperture 46 through which portions of a section retainer 44 may be inserted through in order to be engaged together. For example, a section fastener 45 may comprise a D-ring fastener, having an aperture 46, which may be riveted or otherwise couple to a section 11, 21, 31. In preferred embodiments, a section retainer 44 may comprise an elongated length of a hook and loop fastener that may be riveted or otherwise coupled to a first section 11, 21, 31, so that the section retainer 44 may be inserted through an aperture 46 of a section fastener 45 of a second section 11, 21, 31, and then those portions may be secured to other portions of the section retainer 44 thereby removably coupling two sections 11, 21, 31, together. In further embodiments, a section retainer 44 may comprise a length of flexible material and/or other type of fastener, such as which may be used for a vehicle retainer 36, which may be engaged to a section fastener 45.

In some embodiments, a section retainer 44 may be coupled to a base section 11 and a section fastener 45 may be coupled to a mid section 21 (and/or a section retainer 44 may be coupled to a mid section 21 and a section fastener 45 may be coupled to a base section 11), and the base section 11 may be removably coupled to the mid section 21 by engaging the section retainer 44 to the section fastener 45. In further embodiments, a section retainer 44 may be coupled to a first mid section 21 and a section fastener 45 may be coupled to a second mid section 21 (and/or a section retainer 44 may be coupled to a second mid section 21 and a section fastener 45 may be coupled to a first mid section 21), and the first mid section 21 may be removably coupled to the second mid section 21 by engaging the section retainer 44 to the section fastener 45. In still further embodiments, a section retainer 44 may be coupled to a mid section 21 and a section fastener 45 may be coupled to a top section 31 (and/or a section retainer 44 may be coupled to a top section 31 and a section fastener 45 may be coupled to a mid section 21), and the mid section 21 may be removably coupled to the top section 31 by engaging the section retainer 44 to the section fastener 45.

While some exemplary shapes and sizes have been provided for elements of the device 100, it should be understood to one of ordinary skill in the art that a section 11, 21, 31, insert 42, cap 13, cushion 35, retainer 36, 44, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1. A vehicle rack ramp device, the device including a first ramp, the first ramp having:
an elongated base section having a base surface;
an elongated first mid section having a first mid surface;
an elongated second mid section having a second mid surface;
an elongated top section having a top surface, a distal end, and a proximal end;
a cushion coupled to the top section so that the cushion is positioned closer to the distal end than to the proximal end; and
a vehicle retainer coupled to the top section so that the vehicle retainer is positioned closer to the distal end than to the proximal end, wherein the base section is removably coupled to the first mid section so that the base surface is continuous with the first mid surface, wherein the first mid section is removably coupled to the second mid section so that the first mid surface is continuous with the second mid surface, wherein the proximal end of the top section is removably coupled to the second mid section so that the second mid surface is continuous with the top surface.

2. The device of claim 1, wherein the base section is coupled to the first mid section by one of: inserting a portion of the base section into a portion of the first mid section; and inserting a portion of the first mid section into a portion of the base section.

3. The device of claim 1, wherein the top section is coupled to the second mid section by one of: inserting a portion of the top section into a portion of the second mid section; and inserting a portion of the second mid section into a portion of the top section.

4. The device of claim 1, wherein the first mid section is coupled to the second mid section by one of: inserting a portion of the first mid section into a portion of the second mid section; and inserting a portion of the second mid section into a portion of the first mid section.

5. The device of claim 1, further comprising a first section retainer and a first section fastener wherein the base section is removably coupled to the first mid section by engaging the first section retainer to the first section fastener.

6. The device of claim 5, wherein the first section retainer comprises a hook and loop fastener.

7. The device of claim 1, further comprising a second section retainer and a second section fastener wherein the first mid section is removably coupled to the second mid section by engaging the second section retainer to the second section fastener.

8. The device of claim 7, wherein the second section retainer comprises a hook and loop fastener.

9. The device of claim 1, further comprising a third section retainer and a third section fastener wherein the second mid section is removably coupled to the top section by engaging the third section retainer to the third section fastener.

10. The device of claim 9, wherein the third section retainer comprises a hook and loop fastener.

11. The device of claim 1, wherein the vehicle retainer comprises a hook and loop fastener.

12. The device of claim 1, wherein the base section comprises a base surface dimension (S1) and a base length dimension (L1), wherein the base surface dimension (S1) extends at least 80 percent of the base length dimension (L1).

13. The device of claim 1, wherein the first mid section comprises a first mid surface dimension (S2) and a first mid length dimension (L2), wherein the first mid surface dimension (S2) extends at least 80 percent of the first mid length dimension (L2).

14. The device of claim 1, wherein the second mid section comprises a second mid surface dimension (S2) and a second mid length dimension (L2), wherein the second mid surface dimension (S2) extends at least 80 percent of the second mid length dimension (L2).

15. The device of claim 1, wherein the top section comprises a top surface dimension (S3) and a top length dimension (L3), wherein the top surface dimension (S3) extends at least 80 percent of the top length dimension (L3).

16. A vehicle rack ramp device, the device including a first ramp, the first ramp having:
an elongated base section having a base surface;
an elongated mid section having a mid surface;
an elongated top section having a top surface, a distal end, and a proximal end;
a cushion coupled to the top section so that the cushion is positioned closer to the distal end than to the proximal end; and
a vehicle retainer coupled to the top section so that the vehicle retainer is positioned closer to the distal end than to the proximal end, wherein the base section is removably coupled to the mid section so that the base surface is continuous with the mid surface, wherein the proximal end of the first top section is removably coupled to the mid section so that the mid surface is continuous with the top surface.

17. The device of claim 16, wherein the vehicle retainer comprises a hook and loop fastener.

18. The device of claim 16, further comprising a first section retainer and a first section fastener wherein the base section is removably coupled to the first mid section by engaging the first section retainer to the first section fastener; and further comprising a second section retainer and a second section fastener wherein the first mid section is removably coupled to the top section by engaging the second section retainer to the second section fastener.

19. The device of claim 18, wherein a section retainer selected from the group consisting of the first section retainer and the second section retainer comprises a hook and loop fastener.

20. The device of claim 16, wherein the base section comprises a base surface dimension (S1) and a base length dimension (L1), wherein the base surface dimension (S1) extends at least 80 percent of the base length dimension (L1), wherein the first mid section comprises a mid surface dimension (S2) and a mid length dimension (L2), wherein the mid surface dimension (S2) extends at least 80 percent of the mid length dimension (L2), wherein the top section comprises a top surface dimension (S3) and a top length dimension (L3), and wherein the top surface dimension (S3) extends at least 80 percent of the top length dimension (L3).
